(19) United States
(12) Patent Application Publication
(10) Pub. No.: US 2008/0184839 A1
(43) Pub. Date: Aug. 7, 2008

(54) Motorcycle throttle control

(76) Inventors: Mario Negri, Minneapolis, MN (US); Todd Sigfrid, Brooklyn Park, MN (US)

Correspondence Address: John M. Weyrauch;DICKE, BILLIG & CZAJA, PLLC, Suite 2250, 100 South Fifth Street, Minneapolis, MN, 55402, US

(21) Appl. No.: 11/998,298

(22) Filed: Nov. 29, 2007

Related U.S. Application Data
(60) Provisional application No. 60/899,925, filed on Feb. 7, 2007.

(51) Int. Cl. B60K 26/02; G05G 11/00

(52) U.S. Cl. 74/489; 74/531

(57) ABSTRACT

A throttle control for a motorcycle comprises an electromagnet mounted adjacent to a throttle tube on a handle bar of the motorcycle. The throttle tube includes a radial flange on one end that is configured to define at least one slot. An armature plate is positioned between the electromagnet and the radial flange and is configured to define at least one tab that registers with the slot in the radial flange of the throttle tube. The armature plate is moveable between a first position in contact with the electromagnet and a second position spaced from the electromagnet while the tab remains within the slot. When the electromagnet is energized, the armature plate frictionally contacts the electromagnet and fixes the radial position of the throttle tube.

### CROSS-REFERENCE TO RELATED APPLICATIONS

This application claims the benefit of co-pending U.S. Provisional Patent Application Ser. No. 60/899,925, filed Feb. 7, 2007.

### BACKGROUND

The present invention generally relates to motorcycle throttle controls, and more particularly, to an electromagnetic friction throttle control for maintaining a desired throttle setting.

### SUMMARY OF THE INVENTION

The present invention is a motorcycle throttle control for a motorcycle having a handlebar and a throttle tube rotationally supported on the handlebar. The throttle tube has a circumferential flange configured to define at least one slot. The throttle control comprises an electromagnet connected to a handlebar of a motorcycle adjacent to the circumferential flange of the throttle tube. A metal plate is positioned between the electromagnet and the circumferential flange. The metal plate is moveable between a first position in contact with the electromagnet and a second position spaced from the electromagnet. In one embodiment, the metal plate has at least one tab extending from a surface of the metal plate in a direction toward the circumferential flange. The tab of the metal plate extends within the slot of the circumferential flange when the metal plate is in the first position. Means are provided for energizing the electromagnet, whereby the metal plate frictionally contacts the electromagnet when the electromagnet is energized to maintain a rotational position of the throttle tube.

### BRIEF DESCRIPTION OF THE DRAWINGS

FIG. 1 is a perspective view of one embodiment of an electromagnetic throttle control of the present invention mounted to a motorcycle handle bar.

FIG. 2 is an exploded perspective view of the electromagnetic friction throttle control of FIG. 1.

FIG. 3 is a longitudinal sectional view of an assembled electromagnetic friction throttle control of FIG. 2.

FIG. 3A is an enlarged sectional view of an upper portion of the housing of the electromagnet in relation to an aperture plate and throttle tube flange of one embodiment of the present invention.

### DETAILED DESCRIPTION

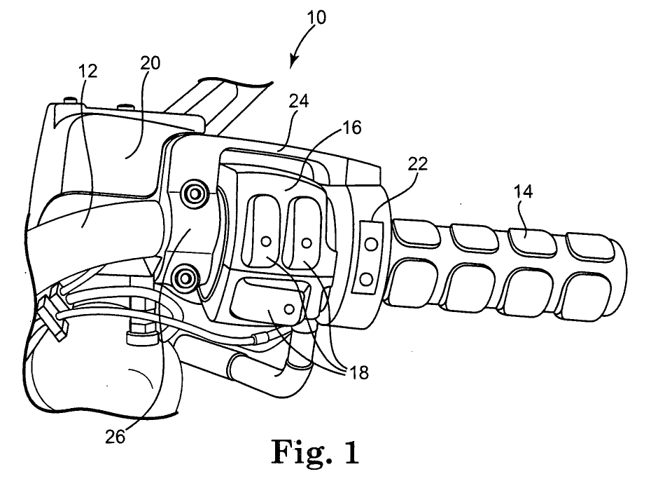

FIG. 1 is a perspective view of an electromagnetic friction throttle control 10 of the present invention mounted to a motorcycle handle bar 12 adjacent to a throttle grip 14. As is common with motorcycle handle bar-mounted throttle controls, throttle grip 14 is located at an end of handle bar 12 and is rotated by the hand of the motorcycle rider to control the rate of fuel flow to the motorcycle engine. Throttle grip 14 is typically biased to a home position representing a low-idle throttle-setting. A control assembly 16 having one or more control buttons 18 is typically mounted to handle bar 12 adjacent to throttle grip 14. A master cylinder housing 20 is commonly mounted to handle bar 12 with a clamping mechanism adjacent to control assembly 16.

In one embodiment, electromagnetic friction throttle control 10 of the present invention generally comprises an electromagnet 22 positioned on handlebar 12 adjacent to throttle grip 14, between control assembly 16 and throttle grip 14. Electromagnet 22 is carried on the end of an arm 24 that is connected to a clamp portion 26. Clamp portion 26 replaces a typical clamp that connects to and secures master cylinder housing 20 relative to handlebar 12. Arm 24 is configured to extend laterally from clamp portion 26 so as to be positioned above control assembly 16. Electromagnet 22 is thereby securely positioned relative to handlebar 12 adjacent to control assembly 16 to cooperate with a mechanism associated with throttle grip 14 to maintain a desired rotational position of throttle grip 14 corresponding to a desired throttle setting.

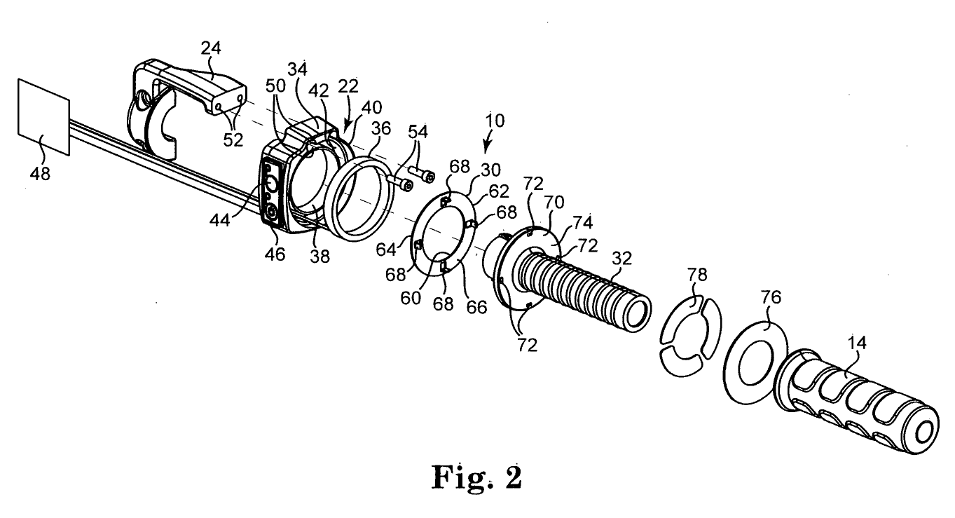

FIG. 2 is an exploded perspective view of one embodiment of the electromagnetic friction throttle control 10. Throttle control 10 generally comprises electromagnet 22, an armature plate 30 and a throttle tube 32. Electromagnet 22 is comprised of a generally cylindrical housing 34 and a coil 36. Housing 34 is constructed from a ferrous metal configured with an inner cylindrical surface 38 sized to be positioned over handlebar 12 and an outer wall 40. Between inner surface 38 and outer wall 40, housing 34 is configured to define a circumferential space 42 to receive coil 36.

In one embodiment, housing 34 includes set switch 44 for activating the electromagnet 22 and a power-off switch 46 for de-activating electromagnet 22. Switches 44 and 46 and coil 36 are electrically coupled to logic circuitry 48 via leads to control power to electromagnet.22. Logic circuitry 48 in turn is electrically coupled to a power source and to leads associated with brake lights and a clutch switch of the motorcycle (not shown). Logic circuitry 48 communicates with the power-off switch 46 in response to a signal representative of the application of the motorcycle brakes and/or actuation of the motorcycle clutch to deactivate electromagnet 22. Housing 34 is configured with a pair of mounting bores 50 for connection of housing 34 to complimentary bores 52 at the end of arm 24. Housing 34 is connected to arm 24 by threaded bolts 54.

Armature plate 30 is comprised of a flat washer-like ferrous metal having an inner circular edge 60 and an outer circular edge 62, which defines a front face 64 and a rear face 66. Inner circular edge 60 has a diameter greater than an outer diameter of handlebar 12 to permit armature plate 30 to move axially relative to handlebar 12. Extending from rear face 66 are one or more flat tabs 68 formed in a stamping process. Tabs 68 extend generally normal to rear face 66 in a direction toward throttle tube 32. As shown in FIG. 2, in one embodiment, armature plate 30 is configured with a plurality of radially spaced tabs 68. Armature plate 30 is attracted to electromagnet 22 when power is delivered to coil 36.

Throttle tube 32 is generally similar to standard motorcycle throttle tubes mounted on handlebar 12 to actuate a cable connected to carburetor throttle plate (not shown). For one embodiment of the present invention, the circumferential flange 70 of throttle tube 32 has been modified to include a plurality of slots 72 through the wall defining flange 70. Slots 72 are radially spaced on flange 72 and oriented to align with and receive tabs 68 of armature plate 30 when the electromagnetic friction throttle control 10 is assembled. The exposed face 74 of the circumferential flange 70 is covered with an aesthetically designed cover plate 76 that is secured to flange 70, such as with a double-faced adhesive tape 78. Throttle grip 14 is positioned over throttle tube 32 in a conventional manner.

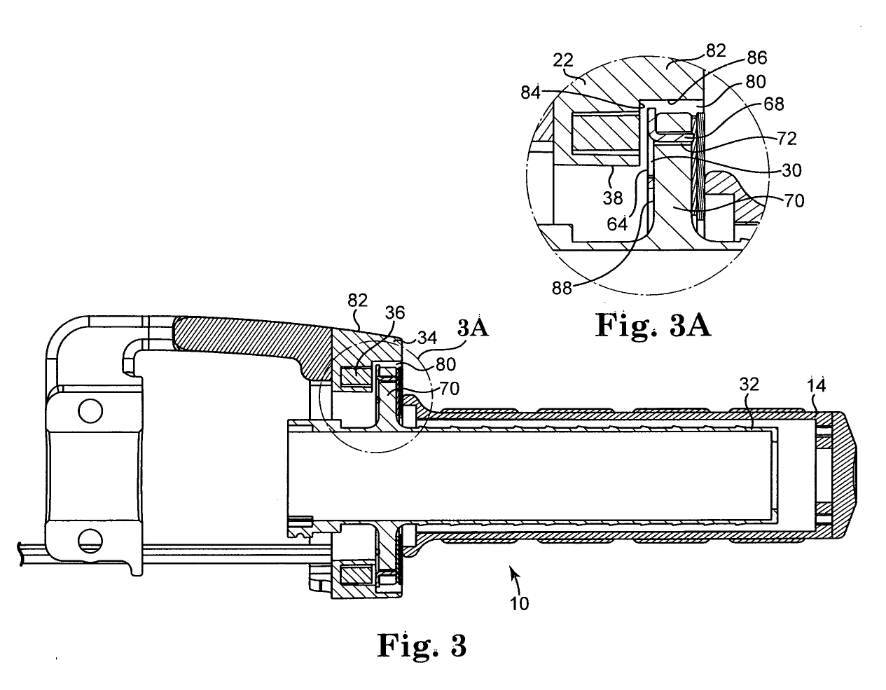

FIG. 3 is a longitudinal sectional view of throttle control 10 with throttle grip 14/throttle tube 32 assembled relative to housing 34. As shown in FIG. 3, flange 70 of throttle tube 32 is sized to fit within a cavity 80 of housing 34 and adjacent to coil 36. Coil 36 is positioned within cavity 42 of housing 34 and is secured therein by a suitable potting material, e.g., silicone. Coil 36 may also be integrally formed with housing 34. FIG. 3A is in an enlarged diagrammatic sectional view of an upper portion 82 of housing 34 to better illustrate one embodiment of the electromagnetic friction throttle control 10. As shown in FIG. 3A, with flange 70 positioned within cavity 80, armature plate 30 is positioned between a radial surface 84 of housing 34 and flange 70. Radial surface 84 generally extends from a first inner circumferential surface 86 that defines a diameter of cavity 80 to inner wall 38 of housing 34. Radial surface 84 is generally in a plane parallel to the plane of flange 70. Surface 88 of flange 70 is spaced from the radial surface 84 of housing 34 sufficiently to allow armature plate 30 a degree of movement while tabs 68 remains within slots 72. When electromagnet 22 is activated, armature plate 30 is attracted into frictional contact with radial surface 84. With armature plate 30 frictionally contacting electromagnet 22, tabs 68 engage slot 72, which prevents rotational movement of flange 70 relative to housing 34. As such, a throttle setting defined by rotational position of throttle grip 14/throttle tube 32 can be maintained, allowing an operator of the motorcycle temporary relief from having to manually maintain a particular throttle setting. While the frictional contact of armature plate 30 with electromagnet 22 is sufficient to maintain a rotational position of throttle grip 14/throttle tube 32, throttle grip 14 can still rotated by the motorcycle rider while the electromagnet 22 is activated. As previously described, electromagnet 22 is deactivated and frictional contact with armature plate 30 ceases when the motorcycle brakes and/or the motorcycle clutch are actuated, or when power-off switch 46 is manually selected.

Although specific embodiments have been illustrated and described herein, it will be appreciated by those of ordinary skill in the art that a variety of alternate and/or equivalent implementations of the present invention may be substituted for the specific embodiments shown and described without departing from the scope of the present invention. For example, present invention has been disclosed with an armature plate having flat tabs that engage complimentary slots on the flange of a throttle tube. In general, other key/key slot arrangements that permit longitudinal movement of the armature plate relative to the throttle tube, yet keep the armature plate in register with the throttle tube are contemplated without departing from the scope of the present disclosure. This application is intended to cover any such adaptations or variations of an electromagnetic friction throttle control beyond the specific embodiments discussed herein.

What is claimed is:

1. A motorcycle throttle control for a motorcycle having a handlebar and a throttle tube rotationally supported on the handlebar, the throttle tube having a circumferential flange, the throttle control comprising:
an electromagnet connected to a handlebar of a motorcycle adjacent to the circumferential flange of the throttle tube;
a metal plate positioned between the electromagnet and the circumferential flange, the metal plate moveable between a first position in contact with the electromagnet and a second position spaced from the electromagnet, the metal plate having at least one tab extending from a surface of the metal plate in a direction toward the circumferential flange;
wherein the circumferential flange is configured-to define at least one slot, the tab of the metal plate extending within the slot when the metal plate is in the first position; and
means for energizing the electromagnet, whereby the metal plate frictionally contacts the electromagnet when the electromagnet is energized to maintain a rotational position of the throttle tube.

2. The motorcycle throttle control of claim 1 wherein electromagnet comprises a ferrous metal housing and a coil positioned within the housing, the housing defining a surface oriented in a plane generally parallel with the circumferential flange, wherein the metal plate contacts the surface of the housing when the metal plate is in the first position.

3. The motorcycle throttle control of claim 2 wherein the housing comprises a generally cylindrical housing having an inner cylindrical surface configured to position the housing over the handlebar, wherein the surface comprises a radial surface.

4. The motorcycle throttle control of claim 2 wherein the housing comprises a circumferential space, the coil positioned within the circumferential space.

5. The motorcycle throttle control of claim 2 wherein the coil is integrally formed with the housing.

6. The motorcycle throttle control of claim 2 and further comprising a clamp secured to the motorcycle handlebar spaced from the housing and an arm having a first end and a second end, the first end connected to the clamp, the second end of the arm connected to the housing.

7. The motorcycle throttle control of claim 1 wherein the metal plate comprises a circular metal plate having an inner circular edge and an outer circular edge, the inner circular edge having a diameter larger than a diameter of the handlebar.

8. The motorcycle throttle control of claim 7 wherein the metal plate comprises a plurality of radially spaced tabs and wherein the circumferential flange is configured to define a plurality of radially spaced slots, the plurality of tabs communicating with the plurality of slots.

9. A motorcycle throttle control for a motorcycle having a handlebar and a throttle tube rotationally supported on the handlebar, the throttle tube having a circumferential flange, the throttle control comprising:
means connected to a handlebar of a motorcycle adjacent to the circumferential flange of the throttle tube for generating an electromagnetic field;
means for reversibly coupling the circumferential flange to the electromagnetic generating means to maintain a rotational position of the throttle tube.
